(19) United States
(12) Patent Application Publication
(10) Pub. No.: US 2014/0117295 A1
(43) Pub. Date: May 1, 2014

(54) APPARATUS FOR EXTRACTING A STAKE FROM THE GROUND

(71) Applicant: GENE DOUGLAS SHAW, TULARE, CA (US)

(72) Inventor: GENE DOUGLAS SHAW, TULARE, CA (US)

(21) Appl. No.: 14/065,409

(22) Filed: Oct. 28, 2013

Related U.S. Application Data
(60) Provisional application No. 61/720,752, filed on Oct. 31, 2012.

(51) Int. Cl. B66F 3/00

(52) U.S. Cl. CPC B66F 3/005
USPC 254/30

(57) ABSTRACT

A stake removal apparatus for extracting the stake from a portion of a ground includes a base plate with a first end and a second end, a handle bar affixed to a top portion of the base plate, a pair of wheels pivotably mounted to the base plate at the first end of the base plate, a C-shaped member pivotably mounted to the second end of the base plate to engage the stake, the C-shaped member having a pair of opposing inner beveled edges that are substantially parallel to one another. A user may orient the C-shaped member to enclose the stake and apply a downward force on the handle bar to enable the inner beveled edges of the C-shaped member to pivot and contact the stake, thereby concentrating the forces applied to the stake to extract the stake from the ground.

### RELATED APPLICATION

The application claims priority to provisional patent application U.S. Ser. No. 61/720,752 filed on Oct. 31, 2012, the entire contents of which is herein incorporated by reference.

### BACKGROUND

The embodiments herein relate generally to devices for removing stakes or posts from the ground.

Stakes, posts and rods are driven into the ground in a variety of applications. Often times, it is more difficult to remove the stake from the ground than to drive the stake into the ground. Removal of the stake from the ground can become even more challenging for a user when the ground consists of dense materials or climatic and/or environmental changes that cause the hardening of the ground.

There exists several devices for removing stakes from the ground, such as U.S. Pat. Nos. 8,413,959, 6,978,983 and 4,750,711. However, these devices have limitations because they are bulky and difficult to store, and/or provide a limited amount of leverage when used to remove a stake from the ground. Further, these devices do not effectively compound and concentrate the forces applied to the stake when it is removed from the ground. Therefore, these devices are inefficient and/or impractical.

As such, there is a need in the industry for a stake removal apparatus that addresses the limitations of the prior art. In particular, there is a need in the industry for a compact stake removal apparatus that effectively compounds the forces applied to the stake and provides sufficient leverage to easily remove the stake from the ground.

### SUMMARY

A stake removal apparatus for extracting the stake from a portion of a ground is provided. The apparatus comprises a pair of pivot points and a plate configured to engage the stake and enhance forces applied to the stake during the removal of the stake. The apparatus comprises a base plate comprising a first end and a second end, a handle bar affixed to a top portion of the base plate, a pair of wheels pivotably mounted to the base plate at the first end of the base plate, a C-shaped member pivotably mounted to the second end of the base plate and configured to engage the stake, the C-shaped member comprising a pair of opposing inner beveled edges that are substantially parallel to one another, wherein a user may orient the C-shaped member to enclose the stake and apply a downward force on the handle bar to enable the inner beveled edges of the C-shaped member to pivot and contact the stake, thereby concentrating the forces applied to the stake to extract the stake from the ground.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the stake removal apparatus;

FIG. 2 depicts a sectional view of certain embodiments of the stake removal apparatus taken along line 2-2 in FIG. 1;

FIG. 3 depicts a side view of certain embodiments of the stake removal apparatus in use;

FIG. 4 depicts a side view of certain embodiments of the stake removal apparatus in use; and

FIG. 5 depicts a side view of certain embodiments of the stake removal apparatus in use.

### DETAILED DESCRIPTION OF CERTAIN EMBODIMENTS

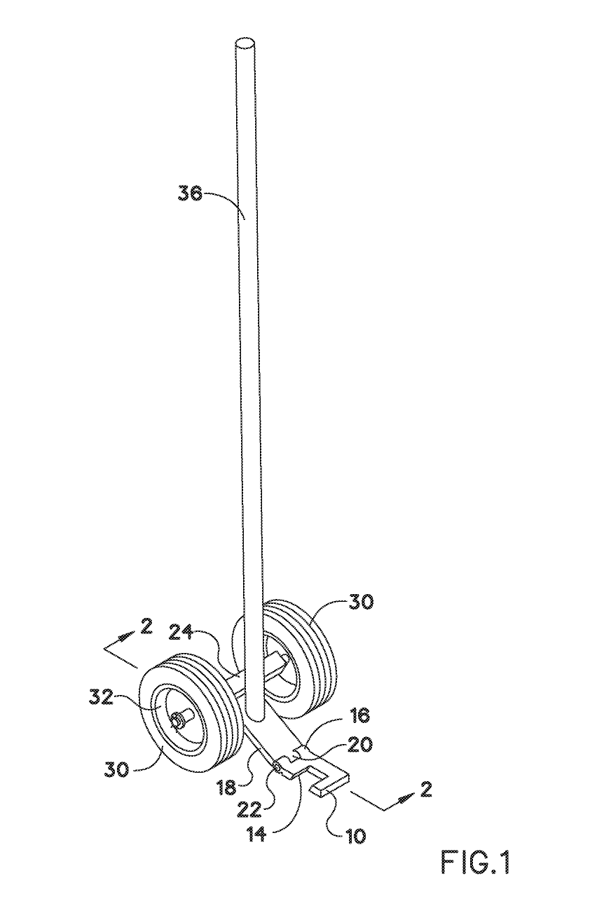

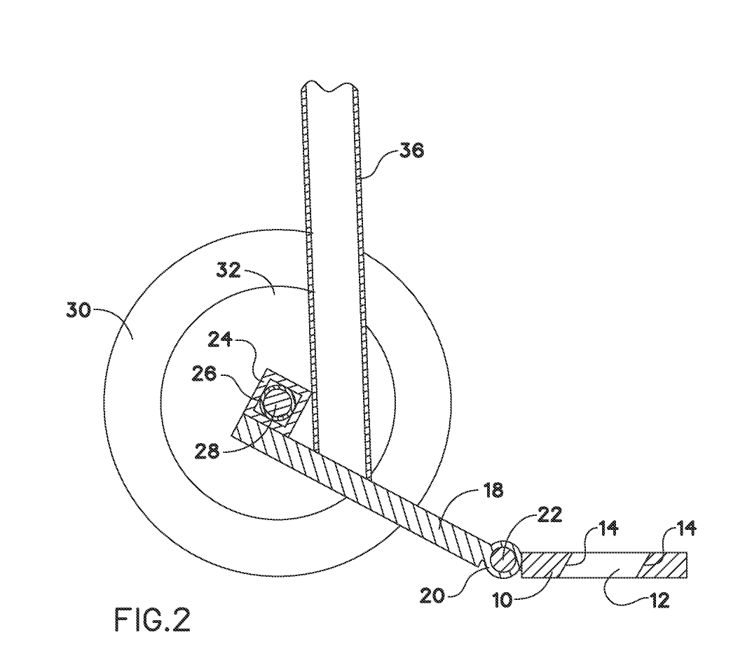

As depicted in FIGS. 1 and 2, the stake removal apparatus comprises C-shaped plate 10, base plate 18, tires 30, tire rims 32, square axle sleeve 24, cylindrical axle sleeve 26, axle 28 and handle 36. C-shaped plate 10 comprises slot 12 and a pair of interior beveled edges 14, which are substantially parallel to one another.

In a preferred embodiment, C-shaped plate 10 is made from steel and has dimensions of 5″×3½″×¾″ with a 2″×2″ slot and ⅜″ beveled edges. C-shaped plate 10 is pivotably mounted to base plate 18 by pin 22 operably connected to C-shaped plate hinge 16 and base plate hinge 20. In a preferred embodiment, pin 22 is a 11/16″ grade 8 pin. However, it shall be appreciated that any alternative pin known in the field may be used. C-shaped plate hinge 16 and base plate hinge 20 comprise three pieces of schedule 40×¾″ steel pipe.

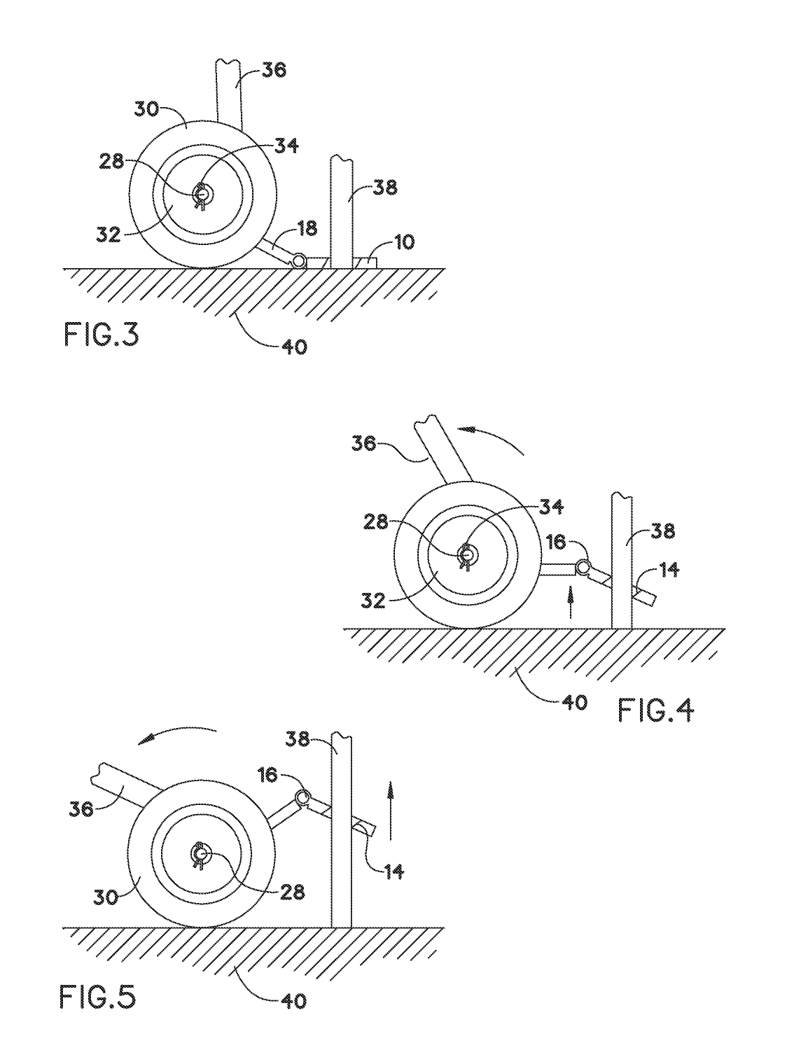

Base plate 18 is made from steel and has dimensions of 8¼″×3½″×¾″. The pair of tires 30 are affixed together by axle 28. Axle 28 is secured within cylindrical axle sleeve 26, which is affixed within the interior of square axle sleeve 24. The sleeves may be welded together or fastened using any other techniques known in the field. Square axle sleeve 24 is welded to base plate 18 and handle 36. In a preferred embodiment, handle 36 is a 1¼″×72″ long schedule 80 pipe that intersects base plate 18 at a 60 degree angle. Axle 28 has an outer diameter of ¾″ and 16″ length. Cylindrical axle sleeve 26 is a schedule 40×¾″ pipe axle sleeve. Square axle sleeve 24 has dimensions of 1½″×¾″×10″. As depicted in FIGS. 3-5, cotter pins 34 are used to secure tires 30 to axle 28. In this configuration, tires 30 are pivotably mounted to base plate 18.

FIGS. 3-5 depict certain embodiments of the stake removal apparatus in use with stake 38 in ground 40. A user orients the apparatus such that stake 38 is within slot 12 of C-shaped plate 10. The user applies a downward force on handle 36, which allows base plate 18 to pivot with respect to tires 30 and C-shaped plate 10 to pivot with respect to base plate 18. During the rotation of handle 36, C-shaped plate 10 engages stake 38 at the intersection of the top face of C-shaped plate 10 and interior beveled edge 14 and the intersection of the opposing interior beveled edge 14 and bottom face of C-shaped plate 10. Since C-shaped plate 10 engages stake 38 at two points of contact as opposed to the entire faces of beveled edges 14, the user can compound the forces applied to stake 38 more effectively to enable the easy removal of stake 38 from ground 40. The forces applied to stake 38 pull stake 38 up and out of ground 40.

It shall be appreciated that the components of the apparatus described in several embodiments herein may comprise any known materials in the field and be of any color, size and/or dimensions. This allows the apparatus to accommodate any variety of stakes. It shall be appreciated that the components of the apparatus described herein may be manufactured and assembled using any known techniques in the field such as standard machining techniques.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A stake removal apparatus for extracting the stake from a portion of a ground, the apparatus comprising a pair of pivot points and a plate configured to engage the stake and enhance forces applied to the stake during the removal of the stake, the apparatus comprising:
a base plate comprising a first end and a second end;
a handle bar affixed to a top portion of the base plate;
a pair of wheels pivotably mounted to the base plate at the first end of the base plate;
a C-shaped member pivotably mounted to the second end of the base plate and configured to engage the stake, the C-shaped member comprising a pair of opposing inner beveled edges that are substantially parallel to one another;
wherein a user may orient the C-shaped member to enclose the stake and apply a downward force on the handle bar to enable the inner beveled edges of the C-shaped member to pivot and contact the stake, thereby concentrating the forces applied to the stake to extract the stake from the ground.

2. The stake removal apparatus of claim 1, wherein the pair of wheels are mechanically coupled to one another by an axle secured within a sleeve that is mechanically coupled to the first end of the base plate.

3. The stake removal apparatus of claim 2, wherein the sleeve comprises a cylindrical tubular sleeve mechanically coupled to a rectangular tubular sleeve.

4. The stake removal apparatus of claim 3 further comprising a cotter pin affixed to each wheel to secure the wheel to the axle.

5. The stake removal apparatus of claim 4, wherein the rectangular tubular sleeve is mechanically coupled to the handle bar.

6. The stake removal apparatus of claim 5, wherein the handle bar intersects the base plate at a 60 degree angle.

7. The stake removal apparatus of claim 6, wherein the base plate is rectangular.
